(19) United States
(12) Patent Application Publication
(10) Pub. No.: US 2013/0257834 A1
(43) Pub. Date: Oct. 3, 2013

(54) APPARATUS FOR CONTROLLING LIGHT OF DIGITAL DEVICE BASED ON IMAGE AND CONTROL METHOD THEREOF

(71) Applicant: Electronics and Telecommunications Research Institute, (US)

(72) Inventors: Ji Yeon KIM, Daejeon (KR); Deockgu JEE, Daejeon (KR); Mi Ryong PARK, Gyeonggi-do (KR); Hyun Woo OH, Daejeon (KR); Jong Hyun JANG, Daejeon (KR); Kwang Roh PARK, Daejeon (KR)

(73) Assignee: ELECTRONICS AND TELECOMMUNICATIONS RESEARCH INSTITUTE, Daejeon (KR)

(21) Appl. No.: 13/727,050

(22) Filed: Dec. 26, 2012

(30) Foreign Application Priority Data
Apr. 3, 2012 (KR) 10-2012-0034338

(51) Int. Cl. G09G 3/16

(52) U.S. Cl. CPC G09G 3/16
USPC 345/207

(57) ABSTRACT

The present invention relates to an apparatus for controlling light of a digital device based on an image and a control method thereof and can improve sensory effects by collecting light characteristic information of digital devices built in the playing environment based on an image played by an image player to extract an optimal light effect, improve the use efficiency of the digital devices by using the home network and the light of the two-way communicable digital devices to improve the sensory effects, and prevent personal information from being leaked in public and commercial facilities by allowing users to select the application of the received light control signal without collecting the light characteristic information of the mobile communication terminals when applying the sensory effects by controlling the light of the mobile communication terminals.

### CROSS-REFERENCES TO RELATED APPLICATIONS

The present application claims priority under 35 U.S.C 119(a) to Korean Application No. 10-2012-0034338, filed on Apr. 3, 2012, in the Korean Intellectual Property Office, which is incorporated herein by reference in its entirety set forth in full.

### BACKGROUND

Exemplary embodiments of the present invention relate to an apparatus for controlling light of a digital device based on an image and a control method thereof, and more particularly, to an apparatus for controlling light of a digital device based on an image capable of improving sensory effects by collecting light characteristic information of digital devices built in the playing environment based on an image played by an image player to extract an optimal light effect and a control method thereof.

As multimedia contents are various and a home network remote control technology is grown, a home network user wants to enjoy more realistic multimedia contents by controlling home network environment such as sound, light, vibration, fragrance, atmosphere, and the like, while watching media at home.

Further, various multimedia devices are released and contents are more abundant accordingly. However, concentration of contents felt by users show a large difference according to individual environment and service environment, such that contents provider's intention cannot be reflected as he/she wishes.

As the related art, there is Korean Patent Laid-Open No. 10-2011-0076297 (Jul. 6, 2011, Title of the Invention: System For Controlling Light Based On Multimedia Contents).

Therefore, many users find isolated places such as a dark theater, and the like, so as to overcome the above problems or watch media by constructing a home theater apparatus and a home network so as to resolve the above problems at home.

However, the above methods focus on obtaining sensory effects based on an acoustic effect and a high resolution screen display.

Further, the method for giving a light effect has merely an on/off function of a light apparatus and therefore, can show the actual sensory effects felt by users by representing a change in brightness of a screen of playing media only at a bright and dark degree.

The above-mentioned technical configuration is a background art for helping understanding of the present invention and does not mean related arts well known in a technical field to which the present invention pertains.

### SUMMARY

An embodiment of the present invention is directed to an apparatus for controlling light of a digital device based on an image capable of improving sensory effects by collecting light characteristic information of digital devices built in the playing environment based on an image played by an image player to extract an optimal light effect and a control method thereof.

Further, an embodiment of the present invention is directed to an apparatus for controlling light of a digital device based on an image capable of improving sensory effects based on a setting therein without collecting light characteristic information of mobile communication terminals so as to protect personal information when applying the sensor effects by controlling light of the mobile communication terminals and a control method thereof.

An embodiment of the present invention relates to an apparatus for controlling light of a digital device based on an image, including: a light control unit configured to output a light control signal for controlling light of a digital device according to sensory effect algorithms by collecting light characteristic information from a digital device including lights located therearound and analyzing an image received from an image player; a storage unit stores the light characteristic information and the sensory effect algorithms of the digital device collected from the light control unit; and a communication unit configured to receive the light characteristic information through near field communication with the digital device, transmit the received light characteristic information to the light control unit, and transmit the light control signal output from the light control unit to the digital device.

The apparatus for controlling light of a digital device may further include: an input unit configured to instruct a collection of the light characteristic information on the digital device to the light control unit and stop the light control.

Another embodiment of the present invention relates to a method for controlling light of a digital device based on an image, including: collecting, by a light control unit, light characteristic information from a digital device and storing the collected light characteristic information in a storage unit; analyzing, by the light control unit, the light characteristic information to acquire controllable information of the digital device; selecting, by the light control unit, sensory effect algorithms for the digital device according to the controllable information; analyzing, by the light control unit, an image input from an image player to generate sensory effects; and transmitting, by the light control unit, a light control signal for generating the sensory effects based on the sensory effect algorithms to the digital device.

The method for controlling light of a digital device may further include: receiving, by the light control unit, an operating state from the digital device receiving the light control signal.

In the collecting of the light characteristic information and the storing of the collected light characteristic information in the storage unit, the light control unit may transmit a request signal requesting the light characteristic information to the digital device.

The request signal requesting the light characteristic information may further include a setting signal to set whether sensor effects of a mobile communication terminal is applied.

If it is determined that the sensory effects are applied to the mobile communication terminal according to the setting signal, upon receiving the light control signal, the mobile communication terminal may control light according to the sensory effect algorithms.

If it is determined that the sensory effects are partially applied to the mobile communication terminal according to the setting signal, upon receiving the light control signal, the mobile communication terminal may control light according to a partially set portion among the sensory effect algorithms.

The sensory effect algorithm may include an illuminance change algorithm, a color change algorithm, and a color change algorithm according to an area.

The controllable information may include at least any one of whether color is displayed, the number of displayable colors, an illuminance level, a heat rate, an operating state, and a selection of an operation device.

### BRIEF DESCRIPTION OF THE DRAWINGS

The above and other aspects, features and other advantages will be more clearly understood from the following detailed description taken in conjunction with the accompanying drawings, in which:

FIG. 1 is a block configuration diagram illustrating an apparatus for controlling light of a digital device based on an image in accordance with an embodiment of the present invention;

FIG. 2 is an exemplified diagram illustrating a state in which an apparatus for controlling light of a digital device based on an image in accordance with an embodiment of the present invention is applied; and

FIG. 3 is a flow chart illustrating a method for controlling light of a digital device based on an image in accordance with an embodiment of the present invention.

### DESCRIPTION OF SPECIFIC EMBODIMENTS

Hereinafter, an apparatus for controlling light of a digital device based on an image and a control method thereof in accordance with embodiments of the present invention will be described with reference to the accompanying drawings. During the process, a thickness of lines, a size of components, or the like, illustrated in the drawings may be exaggeratedly illustrated for clearness and convenience of explanation. Further, the following terminologies are defined in consideration of the functions in the present invention and may be construed in different ways by intention or practice of users and operators. Therefore, the definitions of terms used in the present description should be construed based on the contents throughout the specification.

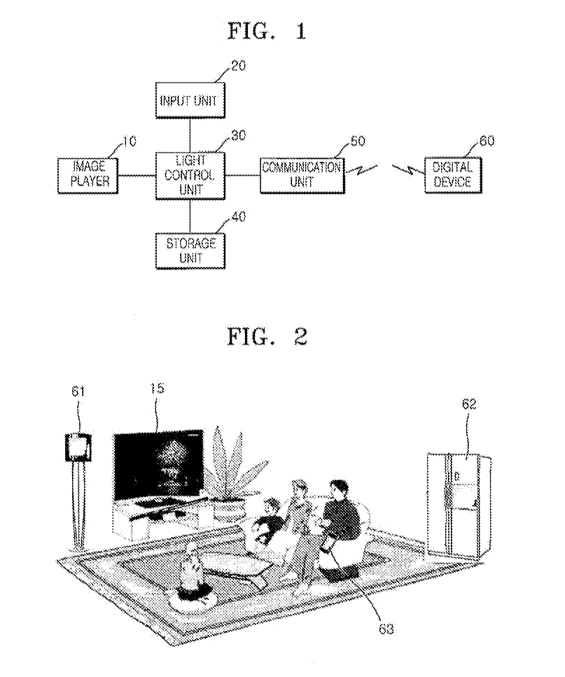

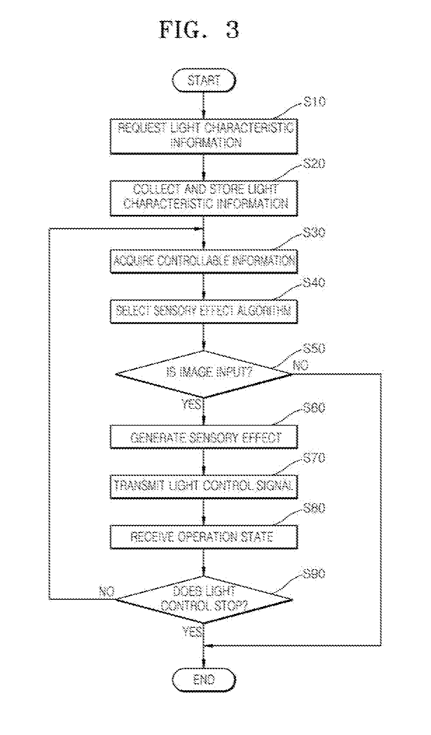

FIG. 1 is a block configuration diagram illustrating an apparatus for controlling light of a digital device based on an image in accordance with an embodiment of the present invention and FIG. 2 is an exemplified diagram illustrating a state in which an apparatus for controlling light of a digital device based on an image in accordance with an embodiment of the present invention is applied.

As illustrated in FIG. 1, a light control apparatus of digital devices based on an image in accordance with the embodiment of the present invention includes a light control unit 30, a storage unit 40, and a communication unit 50, and an input unit 20.

The light control unit 30 outputs a light control signal for controlling light of a digital device 60 according to a sensory effect algorithm by collecting light characteristic information from the digital device 60 mounted with the image player 10 and including lights located therearound and analyzing an image received from the image player 10.

The storage unit 40 stores the light characteristic information and the sensory effect algorithm of the digital device 60 collected from the light control unit 30.

The light characteristic information of the digital devices 60 stored in the storage unit 40 allocates ID to the digital device 60 and is stored in the storage unit 60 in a database form.

The sensory effect algorithm includes an illuminance change algorithm, a color change algorithm, and a color change algorithm according to an area.

As the kind of digital device 60, there are devices including only light of which the illuminance is changed, including on/off, devices capable of changing brightness and front color, devices capable of freely changing all colors and brightness. Therefore, the storage unit stores algorithms that can be applied to these devices.

The communication unit 50 communicates with the digital device 60 in two ways using near field communication such as a home network based on radio frequency Identification (RFID) and digital living network alliance (DLNA) and receives the light characteristic information and transmits the received light characteristic information to the light control unit 30 and transmits the light control signal output from the light control unit 30 to the digital device 60.

Further, the input unit 20 commands a collection of the light characteristic information on the digital device 60 to the light control unit 30 so as to add or initialize a new digital device 60 and receives an event so as to stop a light control for the sensory effects.

The light control apparatus of the digital device based on an image configured as described above allows the light control unit 30 to collect the light characteristic information from the digital device 60 including lights located therearound through the communication unit 50 to select the sensory effect algorithm according to controllable information of the digital device 60 and analyze the image input from the image player 10 to output the light control signal for generating the sensory effect according to the sensory effect algorithm, thereby controlling illuminance and colors of lights of the digital device 60 located therearound corresponding to an image played by the image player 10.

For example, as illustrated in FIG. 2, in the case in which a television 15 that is the image player 10 is mounted in a living room and a refrigerator 62, a mobile communication terminal 63, a wall-pad 61 as the digital device 60 including a light are mounted around the television 15, when a representative color played by the television 15 is “blue”, the light of the refrigerator 62, the mobile communication terminal 63, and the wall pad 61 is controlled to be blue, such that the sensory effects of media can be increased.

FIG. 3 is a flow chart illustrating a method for controlling light of a digital device based on an image in accordance with an embodiment of the present invention.

As illustrated in FIG. 3, a method for controlling light of a digital device based on an image in accordance with an embodiment of the present invention first allows the light control unit 30 to transmit a request signal requesting the light characteristic information to the digital device 60 so as to collect the light characteristic information from the digital device 60 using the home network and the near field communication (S10).

In this case, the request signal further includes a setting signal that can set whether the sensory effects of the mobile communication terminal 63 are applied and thus, the user can set whether the sensory effects are applied according to a setting signal requested from the mobile communication terminal 63.

The user sets whether the sensory effects are the mobile communication terminal 63 according to the setting signal so as to prevent personal information from being collected, thereby protecting personal information.

Further, when intending to set whether the sensory effects are the mobile communication terminal, the overall setting may also be made and a partial setting other than a vibration effect, and the like, in consideration of battery consumption, and the like, of the mobile communication terminal 63 can be made.

As such, the light characteristic information collected after allowing the light control unit to make a request from the digital device 30 including lights located therearound is stored (S20).

Next, the controllable information of the digital device 60 is acquired by analyzing the collected light characteristic information (S30).

That is, information on whether color can be displayed, the number of displayable colors, an illuminance level, a heat rate, an operating state, a selection of an operation device, and the like, that can control the light of the digital device 60 is acquired.

The sensory effect algorithm for the digital device 60 is selected according to the controllable information of the digital device 60.

As the kind of digital devices 60 for controlling light, there are devices including only light of which the illuminance is changed, including on/off, devices capable of changing brightness and front color, devices capable of freely changing all colors and brightness.

Therefore, the sensory effect algorithm that can be applied according to the digital device 60 is classified into the illuminance change algorithm, the color change algorithm, and the color change algorithm according to the area and therefore, the sensory effect algorithm is selected according to the controllable information of the digital device 60.

As described above, the process of collecting the light characteristic information of the digital device 60 is performed at the time of initial setting or is performed when being selected by the input unit 20 so as to add a new digital device 60 and performs the light control according to the preset value later.

After the setting, the sensory effect algorithm is selected according to the digital device 60 stored in the storage unit 40 and the operating state of the digital device 60.

Next, when the image is input from the image player 10, the sensory effects are generated by analyzing the input image (S50) (S60).

For example, when the operable device can control only the illuminance level, the brightness is controlled by calculating brightness of a current frame and comparing the calculated brightness with brightness of a previous frame and when the operation device can represent various colors, a representative color of the current frame can be detected while controlling the illuminance level and an order and a location changing various colors corresponding to the change in various colors of the image for the frame can be detected meeting the change in an image.

For generating the colors according to the generated sensory effects, the light control signal is transmitted to the digital device 60 according to the sensory effect algorithm for the digital device 60 (S70).

The digital device 60 receiving the light control signal controls the illuminance level of the light or changes the color and the location of the light of the digital device 60 according to the light control signal, thereby increasing the sensory effect.

Meanwhile, the digital device 60 transmits the operating state of the light for the light control signal to the light control unit 30 to update the controllable information, and thus, can be implemented so as to be excluded when the light control unit 30 selects the sensory effect algorithm (S80).

When the light control stops by the input unit 20 during the performance of the light control for the sensory effect, the light control ends (S90).

Further, when setting whether the sensory effect is applied to the mobile communication terminal 63 according to the setting signal, the mobile communication terminal 63 receives the light control signal to control the light according to the sensory effect algorithm applied to the mobile communication terminal 63, thereby generating the sensory effects.

Meanwhile, when partially setting whether the sensory effects are applied to the mobile communication terminal 63, the light is controlled according to the set portion among the received sensory effect algorithm. That is, even though the vibration generation is included in the sensory effect algorithm in the case in which the vibration effect is excluded, only the light control may be performed without generating vibration.

In accordance with the control method of the light control apparatus of the digital device based on an image in accordance with the embodiment of the present invention, the light control unit 30 collects the light characteristic information from the digital device 60 including a light located therearound through the communication unit 50, selects the sensory effect algorithm according to controllable information of the digital device 60, and analyzes the image input from the image player 10 to output the light control signal for generating the sensory effect according to the sensory effect algorithm, thereby controlling illuminance and colors of lights of the digital device 60 located therearound corresponding to an image played by the image player 10 to improve the sensory effects.

In accordance with the embodiments of the present invention, it is possible to improve the sensory effects by collecting the light characteristic information of the digital devices built in the playing environment based on an image played by the image player to extract the optimal light effect and improve the use efficiency of the digital devices by using the home network and the light of the two-way communicable digital devices to improve the sensory effects.

In addition, in accordance with the embodiments of the present invention, it is possible to prevent personal information from being leaked in public and commercial facilities by allowing users to select the application of the received light control signal without collecting the light characteristic information of the mobile communication terminals when applying the sensory effects by controlling the light of the mobile communication terminals.

Although the embodiments of the present invention have been described in detail, they are only examples. It will be appreciated by those skilled in the art that various modifications and equivalent other embodiments are possible from the present invention. Therefore, the technical protection scope of the present invention should be defined by the appended claims.

What is claimed is:

1. An apparatus for controlling light of a digital device based on an image, comprising:
a light control unit configured to output a light control signal for controlling light of a digital device according to sensory effect algorithms by collecting light characteristic information from the digital device including lights located therearound and analyzing an image received from an image player;
a storage unit configured to store the light characteristic information and the sensory effect algorithms of the digital device collected from the light control unit; and
a communication unit configured to receive the light characteristic information through near field communication with the digital device, transmit the received light characteristic information to the light control unit, and transmit the light control signal output from the light control unit to the digital device.

2. The apparatus of claim 1, further comprising: an input unit configured to instruct a collection of the light characteristic information on the digital device to the light control unit and stop the light control.

3. A method for controlling light of a digital device based on an image, comprising:
collecting, by a light control unit, light characteristic information from a digital device and storing the collected light characteristic information in a storage unit;
analyzing, by the light control unit, the light characteristic information to acquire controllable information of the digital device;
selecting, by the light control unit, sensory effect algorithms for the digital device according to the controllable information;
analyzing, by the light control unit, an image input from an image player to generate sensory effects; and
transmitting, by the light control unit, a light control signal for generating the sensory effects based on the sensory effect algorithms to the digital device.

4. The method of claim 3, further comprising: receiving, by the light control unit, an operating state from the digital device receiving the light control signal.

5. The method of claim 3, wherein in the collecting of the light characteristic information and the storing of the collected light characteristic information in the storage unit, the light control unit transmits a request signal requesting the light characteristic information to the digital device.

6. The method of claim 5, wherein the request signal requesting the light characteristic information further includes a setting signal to set whether sensor effects of a mobile communication terminal is applied.

7. The method of claim 6, wherein if it is determined that the sensory effects are applied to the mobile communication terminal according to the setting signal, upon receiving the light control signal, the mobile communication terminal controls light according to the sensory effect algorithms.

8. The method of claim 6, wherein if it is determined that the sensory effects are partially applied to the mobile communication terminal according to the setting signal, upon receiving the light control signal, the mobile communication terminal controls light according to a partially set portion among the sensory effect algorithms.

9. The method of claim 3, wherein the sensory effect algorithm includes an illuminance change algorithm, a color change algorithm, and a color change algorithm according to an area.

10. The method of claim 3, wherein the controllable information includes at least any one of whether color is displayed, the number of displayable colors, an illuminance level, a heat rate, an operating state, and a selection of an operation device.
